(19) United States
(12) Patent Application Publication
(10) Pub. No.: US 2018/0211661 A1
(43) Pub. Date: Jul. 26, 2018

(54) SPEECH RECOGNITION APPARATUS WITH CANCELLATION PERIOD

(71) Applicant: ALPINE ELECTRONICS, INC., Tokyo (JP)

(72) Inventors: Nobunori KUDO, Fukushima (JP); Ryo SUKEGAWA, Fukushima (JP)

(21) Appl. No.: 15/725,639

(22) Filed: Oct. 5, 2017

(30) Foreign Application Priority Data
Jan. 20, 2017 (JP) 2017-008105

(51) Int. Cl. G10L 15/22; G10L 25/51; G10L 15/32

(52) U.S. Cl. CPC G10L 15/22; G10L 25/51; G10L 2015/225; G10L 2015/223; G10L 15/32

(57) ABSTRACT

A speech recognition apparatus includes a recognition unit configured to perform, in response to audio data, a recognition process with respect to a first word registered in advance and a recognition process with respect to a second word registered in advance, the recognition process with respect to the second word being performed during a cancellation period associated with the first word upon the first word being recognized, and a control unit configured to perform a control operation associated with the recognized first word upon the first word being recognized by the recognition unit, and to cancel the control operation upon the second word being recognized by the recognition unit.

### BACKGROUND OF THE INVENTION

### 1. Field of the Invention

The disclosures herein relate to a speech recognition apparatus, a method of speech recognition, and a speech recognition system.

### 2. Description of the Related Art

In the field of on-vehicle devices or the like, a speech recognition apparatus is utilized that recognizes speech by use of speech recognition technology and performs control operations in accordance with the recognized speech. Use of such a speech recognition apparatus allows a user to perform desired control operations through the speech recognition apparatus without manually operating an input apparatus such as a touchscreen.

In the case of occurrence of false speech recognition, a related-art speech recognition apparatus requires a user to perform cumbersome operations through an input apparatus in order to cancel a control operation performed in response to erroneously recognized speech.

Accordingly, there may be a need to enable easy cancellation of a control operation performed in response to erroneously recognized speech in the case of occurrence of false speech recognition.

### RELATED-ART DOCUMENTS

### Patent Document

### [Patent Document 1] Japanese Patent Application Publication No. 9-292255

### [Patent Document 2] Japanese Patent Application Publication No. 4-177400

### SUMMARY OF THE INVENTION

It is a general object of the present invention to provide a speech recognition apparatus, a method of speech recognition, and a speech recognition system that substantially obviate one or more problems caused by the limitations and disadvantages of the related art.

According to an embodiment, a speech recognition apparatus includes a recognition unit configured to perform, in response to audio data, a recognition process with respect to a first word registered in advance and a recognition process with respect to a second word registered in advance, the recognition process with respect to the second word being performed during a cancellation period associated with the first word upon the first word being recognized, and a control unit configured to perform a control operation associated with the recognized first word upon the first word being recognized by the recognition unit, and to cancel the control operation upon the second word being recognized by the recognition unit.

According to an embodiment, a method of speech recognition includes performing, in response to audio data, a first recognition process with respect to a first word registered in advance and a second recognition process with respect to a second word registered in advance, the second recognition process being performed during a cancellation period associated with the first word upon the first word being recognized by the first recognition process, and performing a control operation associated with the recognized first word upon the first word being recognized by the first recognition process, and cancelling the control operation upon the second word being recognized by the second recognition process.

According to an embodiment, a speech recognition system includes a speech recognition terminal, and one or more target apparatuses connected to the speech recognition terminal through a network, wherein the speech recognition terminal includes a recognition unit configured to perform, in response to audio data, a recognition process with respect to a first word registered in advance and a recognition process with respect to a second word registered in advance, the recognition process with respect to the second word being performed during a cancellation period associated with the first word upon the first word being recognized, and wherein at least one of the target apparatuses includes a control unit configured to perform a control operation associated with the recognized first word upon the first word being recognized by the recognition unit, and to cancel the control operation upon the second word being recognized by the recognition unit.

According to at least one embodiment, a control operation performed in response to an erroneously recognized speech is readily canceled even in the case of occurrence of erroneous speech recognition.

### BRIEF DESCRIPTION OF THE DRAWINGS

Other objects and further features of the present invention will be apparent from the following detailed description when read in conjunction with the accompanying drawings, in which:

FIG. 1 is a drawing illustrating an example of the hardware configuration of a speech recognition apparatus;

FIG. 2 is a drawing illustrating an example of the functional configuration of the speech recognition apparatus according to a first embodiment;

FIG. 3 is a drawing illustrating an example of a first dictionary;

FIG. 4 is a drawing illustrating an example of a second dictionary;

FIG. 5 is a flowchart illustrating an example of a recognition process according to the first embodiment;

FIG. 6 is a graphic chart illustrating an example of the results of an experiment regarding false recognition occurring in the recognition process of the first embodiment;

FIG. 7 is a flowchart illustrating an example of the process performed by the speech recognition apparatus of the first embodiment;

FIG. 8 is a graphic chart illustrating an example of the transition of a score Sc with respect to a target word;

FIG. 9 is a flowchart illustrating an example of a recognition process according to a second embodiment;

FIG. 10 is a drawing illustrating an example of the functional configuration of a speech recognition apparatus according to a third embodiment;

FIG. 11 is a graphic chart illustrating an example of the transition of a score Sc with respect to a target word;

FIG. 12 is a drawing illustrating an example of an adjusting length table;

FIG. 13 is a flowchart illustrating an example of the process performed by the speech recognition apparatus of the third embodiment;

FIG. 14 is a drawing illustrating an example of a speech recognition system according to a fourth embodiment; and

FIG. 15 is a drawing illustrating an example of the functional configuration of the speech recognition system according to the fourth embodiment.

### DESCRIPTION OF THE PREFERRED EMBODIMENTS

In the following, embodiments of the present invention will be described with reference to the accompanying drawings. In respect of descriptions in the specification and drawings relating to these embodiments, elements having substantially the same functions and configurations are referred to by the same reference numerals, and a duplicate description will be omitted.

### First Embodiment

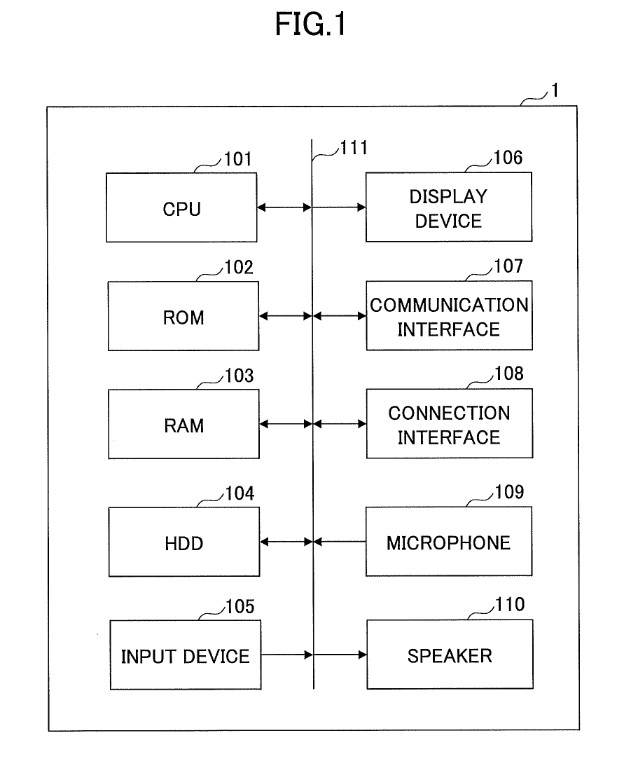

A speech recognition apparatus of a first embodiment will be described by referring to FIG. 1 through FIG. 8. The speech recognition apparatus of the present embodiment is applicable to any apparatuses that recognize speech through speech recognition technology and that perform control operations in accordance with the recognized speech. Such apparatuses include an on-vehicle apparatus, an audio apparatus, a television set, a smartphone, a portable phone, a tablet terminal, a PC (personal computer), a server, and the like. An on-vehicle apparatus may be an on-vehicle audio device, an on-vehicle navigation device, an on-vehicle television device, or an integrated-type apparatus in which all of these devices are consolidated. In the following, a description will be given with respect to an example in which the speech recognition apparatus is implemented as an on-vehicle apparatus (e.g., integrated-type apparatus).

The hardware configuration of a speech recognition apparatus 1 will be described first. FIG. 1 is a drawing illustrating an example of the hardware configuration of the speech recognition apparatus 1. The speech recognition apparatus 1 illustrated in FIG. 1 includes a CPU (central processing unit) 101, a ROM (read only memory) 102, a RAM (random access memory) 103, an HDD (hard disk drive) 104, an input device 105, and a display device 106. The speech recognition apparatus 1 further includes a communication interface 107, a connection interface 108, a microphone 109, a speaker 110, and a bus 111.

The CPU 101 executes programs to control the hardware units of the speech recognition apparatus 1 to implement the functions of the speech recognition apparatus 1.

The ROM 102 stores programs executed by the CPU 101 and various types of data.

The RAM 103 provides a working space used by the CPU 101.

The HDD 104 stores programs executed by the CPU 101 and various types of data. The speech recognition apparatus 1 may be provided with an SSD (solid state drive) in place of or in addition to the HDD 104.

The input device 105 is used to enter information and instruction in accordance with user operations into the speech recognition apparatus 1. The input device 105 may be a touchscreen or hardware buttons, but is not limited to these examples.

The display device 106 serves to display images and videos in response to user operations. The display device 106 may be a liquid crystal display, but is not limited to this example. The communication interface 107 serves to connect the speech recognition apparatus 1 to a network such as the Internet or a LAN (local area network).

The connection interface 108 serves to connect the speech recognition apparatus 1 to an external apparatus such as an ECU (engine control unit).

The microphone 109 is a device for converting surrounding sounds into audio data. In the present embodiment, the microphone 109 is constantly in operation during the operation of the speech recognition apparatus 1.

The speaker 110 produces sound such as music, voice, touch sounds, and the like in response to user operations. The speaker 110 allows the audio function and audio navigation function of the speech recognition apparatus 1 to be implemented.

The bus 111 connects the CPU 101, the ROM 102, the RAM 103, the HDD 104, the input device 105, the display device 106, the communication interface 107, the connection interface 108, the microphone 109, and the speaker 110 to each other.

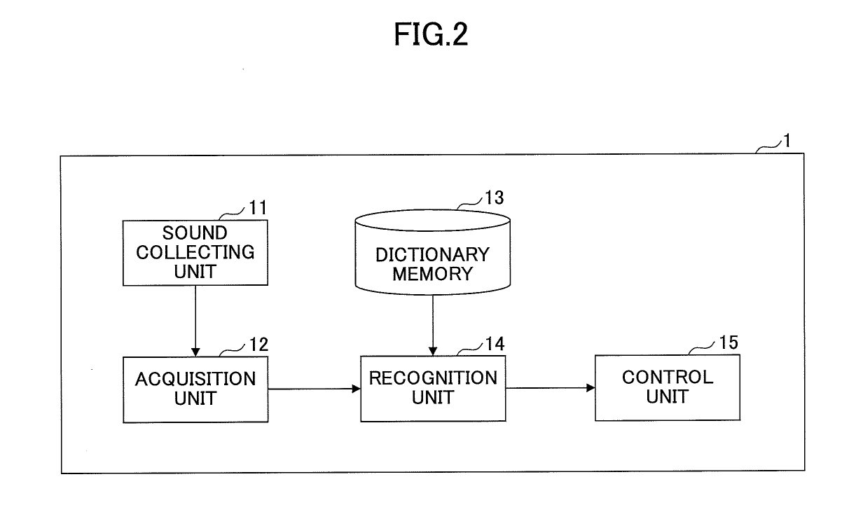

In the following, a description will be given of the functional configuration of the speech recognition apparatus 1 according to the present embodiment. FIG. 2 is a drawing illustrating an example of the functional configuration of the speech recognition apparatus 1 according to the present embodiment. The speech recognition apparatus 1 illustrated in FIG. 2 includes a sound collecting unit 11, an acquisition unit 12, a dictionary memory 13, a recognition unit 14, and a control unit 15. The sound collecting unit 11 is implemented as the microphone 109. The remaining functions are implemented by the CPU 101 executing programs.

The microphone 11 converts surrounding sounds into audio data.

The acquisition unit 12 receives audio data from the sound collecting unit 11, and temporarily stores the received audio data. As the audio data received by the acquisition unit 12 is produced from sounds in a vehicle, the audio data received by the acquisition unit 12 includes various types of audio data corresponding to machine sounds, noises, music, voices, etc. The acquisition unit 12 sends the received audio data to the recognition unit 14 at constant intervals. The interval may be 8 milliseconds, for example, but is not limited to this length.

The dictionary memory 13 stores a dictionary (i.e., table) in which target words (or phrases) are registered in advance. The term “target word” refers to a word (or phrase) that is to be recognized through speech recognition by the speech recognition apparatus 1. In the present disclosures, the term “speech recognition” refers to the act of recognizing words in speech. Namely, the speech recognition apparatus 1 recognizes target words spoken by a user. The term “user” refers to a person who is either the driver or a passenger of the vehicle who operates the speech recognition apparatus 1.

In the present embodiment, the dictionary memory 13 stores a first dictionary and a second dictionary.

The first dictionary has one or more target words registered in advance that are command words (which may also be referred to as “first words”). The command words are words that are used by a user to cause the speech recognition apparatus 1 to perform predetermined control operations. The command words are associated with the control operations of the speech recognition apparatus 1.

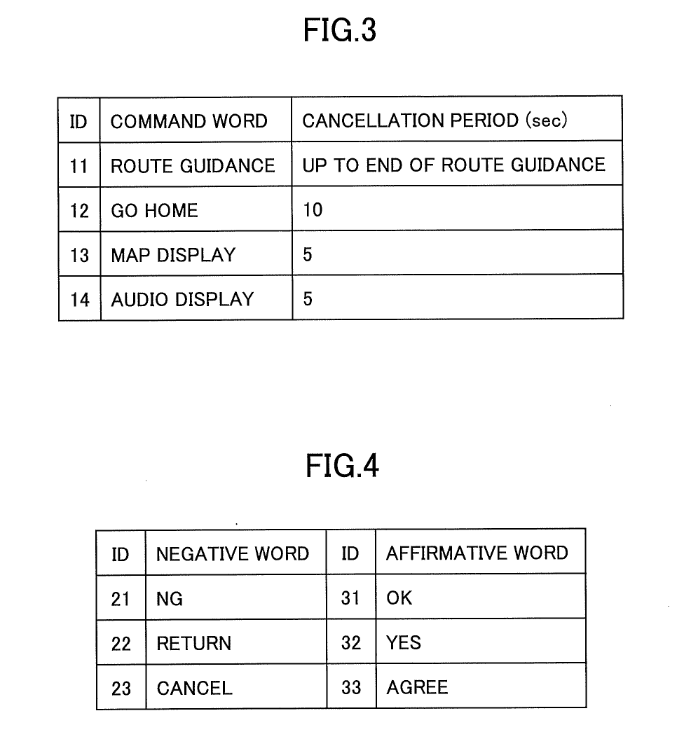

FIG. 3 is a drawing illustrating an example of the first dictionary. As illustrated in FIG. 3, the first dictionary has IDs, command words, and cancellation periods registered therein in one-to-one correspondence with each other. An ID is identification information for identifying a command word. A period is set in advance for each command word. The period will be described later. In the following, a word whose ID is “X” is referred to as word “X”.

In the example illustrated in FIG. 3, the command word “12” (i.e., the command word having the ID “12”) is “go home”, and the cancellation period therefor is 10 seconds. The command word “13” is “map display”, and the cancellation period therefor is 5 seconds. The command word “14” is “audio display”, and the cancellation period therefor is 5 seconds. The cancellation periods for different command words may be different, or may be the same. The command word “11” is “route guidance”, and the cancellation period therefor is “until the end of route guidance”. In this manner, the cancellation period may be set as a period leading up to a certain time or event. The command words are not limited to those examples illustrated in FIG. 3.

The second dictionary has one or more target words registered therein in advance that are either negative words (which may also be referred to as “second words”) or affirmative words (which may also be referred to as “third words”). A negative word is a word used by a user to reject the command word recognized by the speech recognition apparatus 1. An affirmative word is a word used by a user to agree to the command word recognized by the speech recognition apparatus 1.

FIG. 4 is a drawing illustrating an example of the second dictionary. As illustrated in FIG. 4, the second dictionary has IDs and either negative words or affirmative words stored therein in one-to-one correspondence with each other. In the example illustrated in FIG. 4, the negative word “21” is “NG”. The negative word “22” is “return”. The negative word “23” is “cancel”. Further, the affirmative word “31” is “OK”. The affirmative word “32” is “yes”. The affirmative word “33” is “agree”. In this manner, words having negative meaning are set as negative words, and words having affirmative meaning are set as affirmative words. The negative words and affirmative words are not limited to the examples illustrated in FIG. 4.

In response to audio data received from the acquisition unit 12, the recognition unit 14 performs a recognition process with respect to the target words registered in the dictionaries stored in the dictionary memory 13, thereby recognizing a target word spoken by a user. The recognition process performed by the recognition unit 14 will be described later. Upon recognizing a target word, the recognition unit 14 sends the result of recognition to the control unit 15. The result of recognition includes a command word recognized by the recognition unit 14.

The control unit 15 has control operations registered therein that correspond to respective command words registered in the first dictionary. The control unit 15 controls the speech recognition apparatus 1 in response to the result of recognition sent from the recognition unit 14. The method of control by the control unit 15 will be described later.

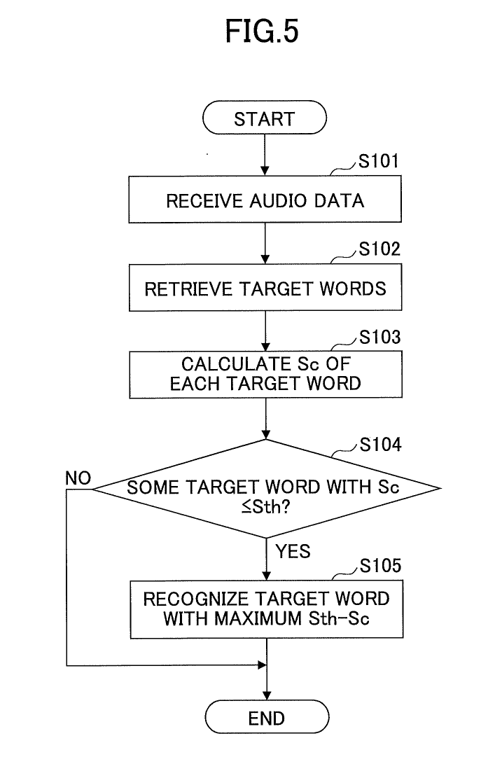

In the following, a description will be given of a recognition process performed by the recognition unit 14 according to the present embodiment. FIG. 5 is a flowchart illustrating an example of a recognition process according to the present embodiment.

The recognition unit 14 receives audio data from the acquisition unit 12 (step S101).

Upon receiving the audio data, the recognition unit 14 refers to the dictionaries stored in the dictionary memory 13 to retrieve the target words registered in the dictionaries (step S102).

Upon retrieving the target words registered in the dictionaries, the recognition unit 14 calculates a score Sc of each of the retrieved target words. The score Sc is the distance between a target word and the audio data. The distance is a value indicative of the degree of similarity between the target word and the audio data. The smaller the distance is, the greater the degree of similarity is. The greater the distance is, the smaller the degree of similarity is. Accordingly, the smaller score Sc a given target word has, the greater degree of similarity such a target word has relative to the audio data. The greater score Sc a given target word has, the smaller degree of similarity such a target word has relative to the audio data. The distance between a feature vector representing a target word and a feature vector extracted from audio data may be used as the score Sc.

After calculating the score Sc of each target word, the recognition unit 14 compares the calculated score Sc of each target word with a preset threshold Sth of the score Sc of each target word, thereby determining whether there is a target word having the score Sc smaller than or equal to the threshold Sth (step S104). The threshold Sth may be different for a different target word, or may be the same.

In the case where no target word has the score Sc smaller than or equal to the threshold Sth (NO in step S104), the recognition unit 14 does not recognize any of the target words.

In the case where one or more target words have the score Sc smaller than or equal to the threshold Sth (YES in step S104), the recognition unit 14 recognizes the target word for which Sth−Sc is the greatest (step S105). Namely, the recognition unit 14 recognizes the target word having the greatest difference between the score Sc and the threshold Sth among the one or more target words having the score Sc smaller than or equal to the threshold Sth.

The recognition process of the present embodiment is a trigger-less process executable at any timing as long as there is audio data. A trigger-less recognition process is suitable for real-time speech recognition. Because of this, the speech recognition apparatus 1 of the present embodiment is suitable for use in applications such as in an on-vehicle apparatus where real-time speech recognition is required.

In general, false recognition such as FR (i.e., false rejection) and FA (i.e., false acceptance) may sometimes occur in speech recognition. FR refers to false recognition in which a spoken word is not recognized despite the fact that the spoken word is a target word. FA refers to false recognition in which a target word is recognized despite the fact that no such target word is spoken.

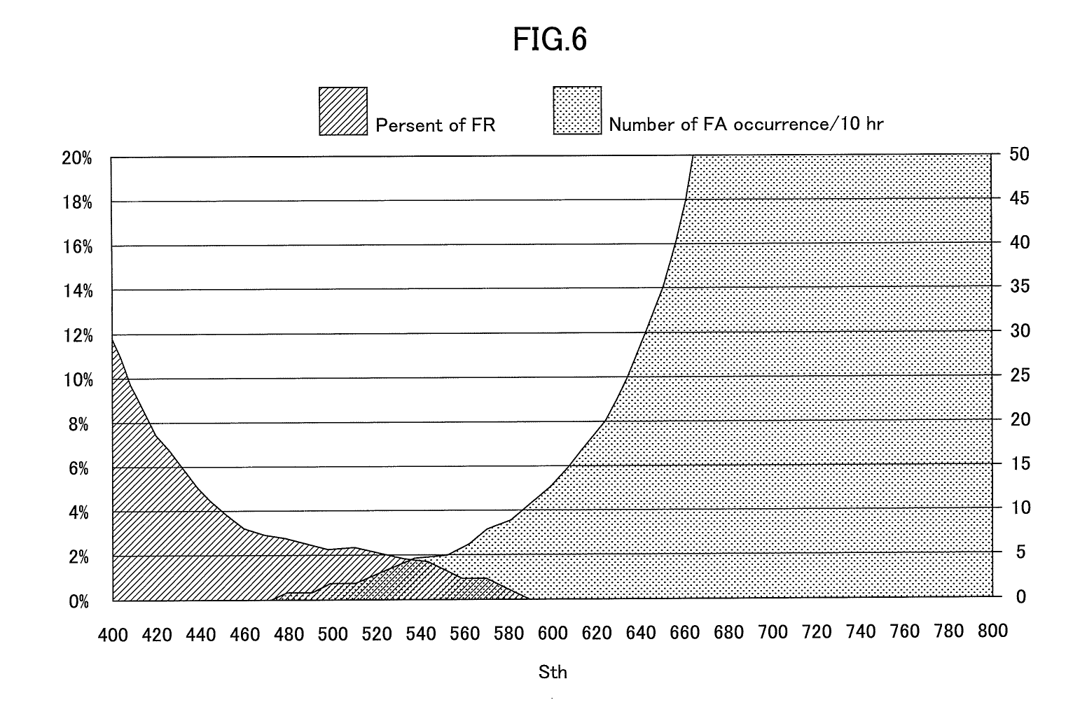

FIG. 6 is a graphic chart illustrating an example of the results of an experiment regarding false recognition occurring in the recognition process of the present embodiment. In FIG. 6, the horizontal axis of FIG. 6 represents the threshold Sth, and the vertical axis on the left-hand side represents the FR rate, with the vertical axis on the right-hand side representing the number of FAs occurring in a period of 10 hours. The diagonally hatched area represents the relationship between the threshold Sth and the FR rate, and the dotted area represents the relationship between the threshold Sth and the number of FA occurrences.

As illustrated in FIG. 6, according to the recognition process of the present embodiment, the greater the threshold Sth is, the larger the number of FA occurrences is. Also, the smaller the threshold Sth is, the greater the FR rate is. Because of this, no matter what value is set to the threshold Sth, the occurrence of false recognition is unlikely to be fully prevented. In consideration of this, the speech recognition apparatus 1 of the present embodiment accepts the fact that false recognition occurs, and takes measures for the occurrence of false recognition such that a control operation responding to the erroneously recognized target word is readily canceled.

In the present embodiment, the threshold Sth of each target word may preferably be set such as to reduce the occurrence of false recognition based on the results of an experiment as illustrated in FIG. 6. In the example of FIG. 6, the threshold Sth may preferably be set between 480 and 580.

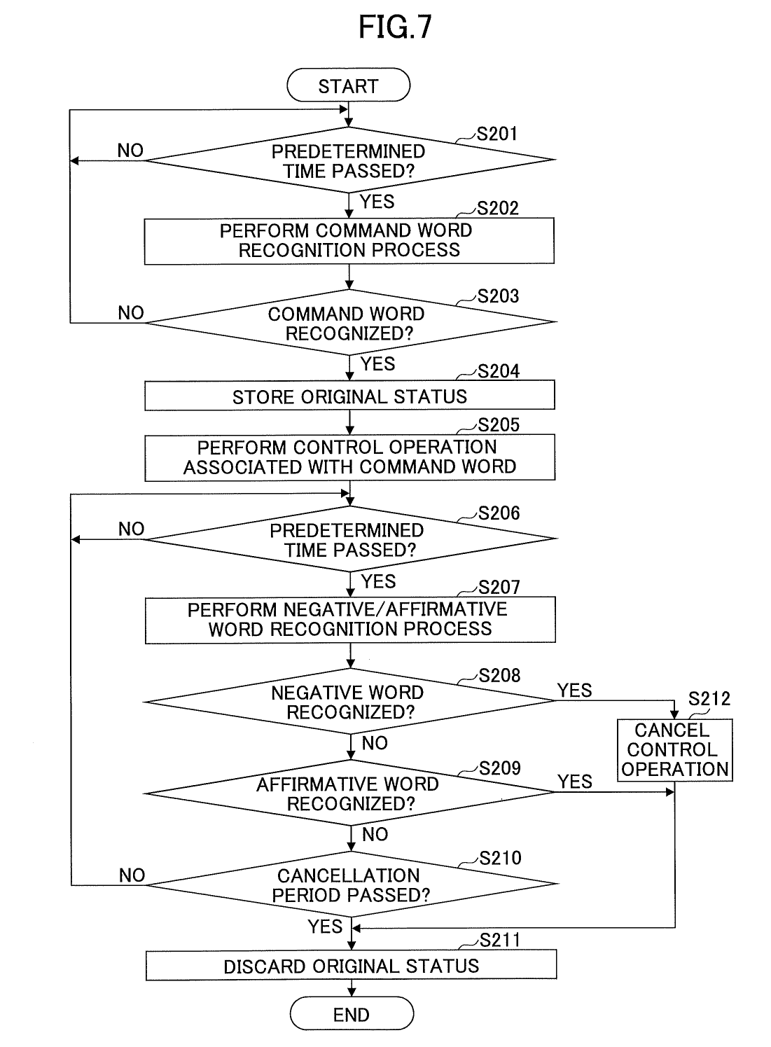

In the following, a description will be given of a process performed by the speech recognition apparatus 1 of the present embodiment. FIG. 7 is a flowchart illustrating an example of the process performed by the speech recognition apparatus 1 of the present embodiment. During the operation of the speech recognition apparatus 1, the sound collecting unit 11 constantly produces audio data. The speech recognition apparatus 1 repeatedly performs the process illustrated in FIG. 7 in response to the produced audio data.

The recognition unit 14 waits for the passage of a predetermined time period following the previous recognition process (NO in step S201). As was previously noted, this predetermined time period may be 8 milliseconds.

Upon the passage of the predetermined time period (YES in step S201), the recognition unit 14 performs a recognition process with respect to command words (step S202). Namely, the recognition unit 14 receives audio data from the acquisition unit 12 (step S101), followed by referring to the first dictionary to retrieve the registered command words (step S102). In so doing, the recognition unit 14 also retrieves the waiting times corresponding to the respective command words. The recognition unit 14 then calculates the score Sc of each command word (step S103), followed by comparing the score Sc with the threshold Sth for each command word to determine whether there is a command word having the score Sc smaller than or equal to the threshold Sth (step S104).

In the case of having recognized no command word (NO in step S203), i.e., in the case of finding no command word having the score Sc smaller than or equal to the threshold Sth (NO in step S104), the recognition unit 14 brings the recognition process to an end. The procedure thereafter returns to step S201. In the manner described above, the recognition unit 14 repeatedly performs the recognition process with respect to command words until a command word is recognized.

In the case of having recognized a command word (YES in step S203), i.e., in the case of finding a command word having the score Sc smaller than or equal to the threshold Sth (YES in step S104), the recognition unit 14 brings the recognition process to an end, and reports the result of recognition to the control unit 15. The recognized command word and the cancellation period corresponding to the recognized command word are reported as the result of recognition. In the case where a plurality of command words have the score Sc smaller than or equal to the threshold Sth, the recognition unit 14 recognizes the command word for which Sth−Sc is the greatest (step S105). At this point, the recognition unit 14 brings the recognition process for command words to an end. The recognition unit 14 subsequently performs a recognition process for negative words and affirmative words.

Upon receiving the result of recognition, the control unit 15 temporarily stores the current status of the speech recognition apparatus 1 (step S204). The status of the speech recognition apparatus 1 includes settings for the destination, active applications, and the screen being displayed on the display device 106. The status of the speech recognition apparatus 1 stored in the control unit 15 will hereinafter be referred to as an original status.

Upon storing the original status, the control unit 15 performs a control operation associated with the command word reported from the recognition unit 14 (step S205). In the case of the reported command word being “map display”, for example, the control unit 15 displays a map on the display device 106.

Subsequently, the recognition unit 14 waits for the passage of a predetermined time period following the previous recognition process (NO in step S206).

Upon the passage of the predetermined time period (YES in step S206), the recognition unit 14 performs a recognition process with respect to negative words and affirmative words (step S207). Namely, the recognition unit 14 receives audio data from the acquisition unit 12 (step S101), followed by referring to the second dictionary to retrieve the registered negative words and affirmative words (step S102). In this manner, upon recognizing a command word, the recognition unit 14 of the present embodiment switches dictionaries to refer to in the dictionary memory 13 from the first dictionary to the second dictionary. The recognition unit 14 then calculates the score Sc of each of the negative words and the affirmative words (step S103), followed by comparing the score Sc with the threshold Sth for each of the negative words and the affirmative words to determine whether there is a negative word or an affirmative word having the score Sc smaller than or equal to the threshold Sth (step S104).

In the case of having recognized none of the negative words and the affirmative words (NO in step S209), i.e., in the case of finding none of the negative words and the affirmative words having the score Sc smaller than or equal to the threshold Sth (NO in step S104), the recognition unit 14 brings the recognition process to an end.

Subsequently, the control unit 15 checks whether the cancellation period has passed since receiving the result of recognition (step S210). Namely, the control unit 15 checks whether the cancellation period corresponding to the command word has passed since the recognition unit 14 recognized the command word.

In the case in which the cancellation period has passed (YES in step S210), the control unit 15 discards the original status of the speech recognition apparatus 1 that was temporarily stored (step S211). This discarding action means that the control operation performed by the control unit 15 in step S207 is confirmed. Subsequently, the speech recognition apparatus 1 resumes the process from step S201. Namely, the recognition unit 14 brings the recognition process for negative words and affirmative words to an end. The recognition unit then performs a recognition process for command words. Even after the confirmation of a control operation, a user may operate the input device 105 to bring the speech recognition apparatus 1 to the original status.

In the case in which the cancellation period has not passed (NO in step S210), the procedure returns to step S206. In this manner, the recognition unit 14 repeatedly performs a recognition process for negative words and affirmative words during the cancellation period following the successful recognition of a command word. Namely, the cancellation period defines the period during which a recognition process for negative words and affirmative words is repeatedly performed.

In the recognition process started in step S207, the recognition unit 14 notifies the control unit 15 of recognition of a negative word in the case of having recognized a negative word (YES in step S208), followed by bringing the recognition process to an end.

Upon being notified of the recognition of a negative word, the control unit 15 cancels the control operation that is started in step S205 in response to the command word (step S212). Namely, the control unit 15 brings the speech recognition apparatus 1 to the original status. The procedure thereafter proceeds to step S211.

In the manner as described above, the control operation associated with the command word is cancelled when a negative word is recognized during the cancellation period. Namely, a user may speak a negative word during the cancellation period to cancel the control operation associated with the command word.

As described above, the cancellation period is the period during which the control operation associated with the command word can be canceled by a spoken negative word. It is thus preferable that the more likely a given command word results in false recognition, the longer the cancellation period is.

In the recognition process started in step S207, the recognition unit 14 notifies the control unit 15 of recognition of an affirmative word in the case of having recognized an affirmative word (YES in step S209), followed by bringing the recognition process to an end. The procedure thereafter proceeds to step S211.

In the manner as described above, the recognition of an affirmative word during the cancellation period causes the control operation associated with the command word to be confirmed without waiting for the passage of the cancellation period. Namely, a user may speak an affirmative word during the cancellation period to confirm the control operation associated with the command word at an earlier time. Consequently, the load on the control unit 15 may be reduced. Further, it is possible to reduce the occurrence of FA (false acceptance) of a negative word that serves to cancel the control operation associated with the command word.

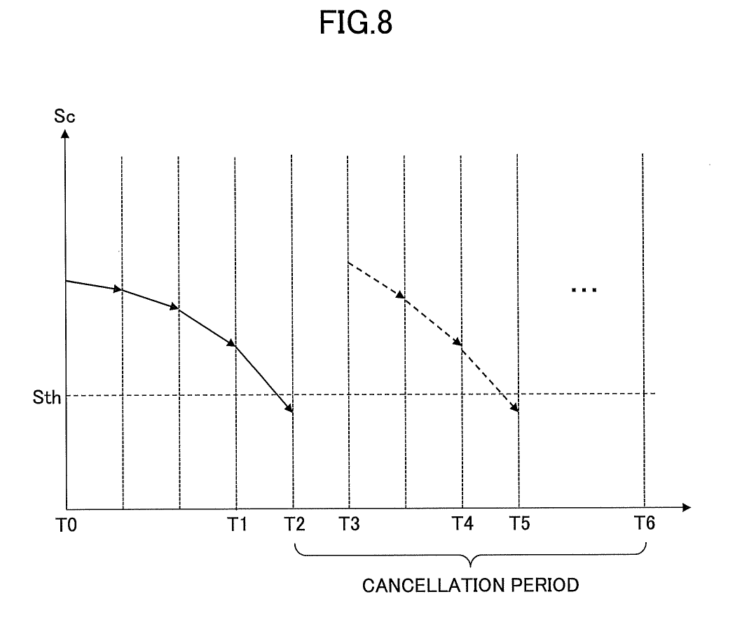

In the following, the process performed by the speech recognition apparatus 1 of the present embodiment will be described in detail by referring to FIG. 8. FIG. 8 is a graphic chart illustrating an example of transition of the score Sc with respect to a target word. In FIG. 8, the horizontal axis represents time, and the vertical axis represents the score Sc, with a dashed horizontal straight line representing the threshold Sth. In FIG. 8, the solid line arrows represent the transitions of the score Sc with respect to a command word, and the dashed line arrows represent the transitions of the score Sc with respect to a negative word. In the description that follows, the arrangement may be such that only one command word and only one negative word are registered. Further, the command word and the negative word have the same threshold Sth. In the example illustrated in FIG. 8, the score Sc of a command word is greater than the threshold Sth between time T0 and time T1, so that the command word is not recognized. As a result, the speech recognition apparatus 1 repeatedly performs the processes of steps S201 through S203 between time T0 and time T1.

At time T2, the score Sc of the command word falls below the threshold Sth. The speech recognition apparatus 1 thus recognizes the command word at time T2 (YES in step S203), and stores the original status (step S204), followed by performing a control operation in response to the command word (step S205).

In the example illustrated in FIG. 8, the cancellation period ranges from time T2 to time T6. During the period from time T3 to time T4, the score Sc of a negative word is greater than the threshold Sth, resulting in the negative word being not recognized. Because of this, the speech recognition apparatus 1 repeatedly performs the processes of steps S206 through S210 between time T3 and time T4.

At time T5, then, the score Sc of the negative word falls below the threshold Sth. The speech recognition apparatus 1 thus recognizes the negative word at time T5 (YES in step S208), and cancels the control operation associated with the command word (step S212), followed by discarding the original status (step S211). Through these processes, the status of the speech recognition apparatus 1 returns to the status that existed prior to the start of the control operation associated with the command word at time T2. Subsequently, the speech recognition apparatus 1 resumes the process from step S201.

As was previously described, the recognition of an affirmative word during the cancellation period causes the speech recognition apparatus 1 to confirm the control operation associated with the command word at the time of recognition of the affirmative word, followed by resuming the procedure from step S201. In the case where the cancellation period has passed without either a negative word or an affirmative word being recognized, the speech recognition apparatus 1 confirms the control operation associated with the command word upon the passage of the cancellation period, followed by resuming the procedure from step S201.

According to the present embodiment described above, a user may speak a negative word during the cancellation period to cancel the control operation associated with the command word. The user is thus readily able to cancel the control operation performed in response to the recognized command word without operating the input device 105 in the case of the command word being erroneously recognized. The resultant effect is to reduce the load on the user and to improve the convenience of use of the speech recognition apparatus 1.

The description that has been provided heretofore is directed to an example in which affirmative words are registered as target words. Alternatively, affirmative words may not be registered as target words. Even in the case of no affirmative words being registered as target words, a user may speak a negative word during the cancellation period to cancel the control operation associated with the command word. In the case of no affirmative words being registered, the speech recognition apparatus 1 may perform the procedure that is left after step S209 is removed from the flowchart of FIG. 7.

Further, the description that has been provided heretofore is directed to an example in which command words are registered in the first dictionary, and negative words and affirmative words are registered in the second dictionary. Alternatively, command words, negative words, and affirmative words may all be registered in the same dictionary. In such a case, the dictionary may have a first area for registering command words and a second area for registering negative words and affirmative words. The recognition unit 14 may switch areas to refer to, thereby switching between the recognition process for command words and the recognition process for negative words and affirmative words. Alternatively, each target word may be registered in the dictionary such that the target word is associated with information (e.g., flag) indicative of the type of the target word. The recognition unit 14 may switch types of target words to refer to, thereby switching between the recognition process for command words and the recognition process for negative words and affirmative words.

### Second Embodiment

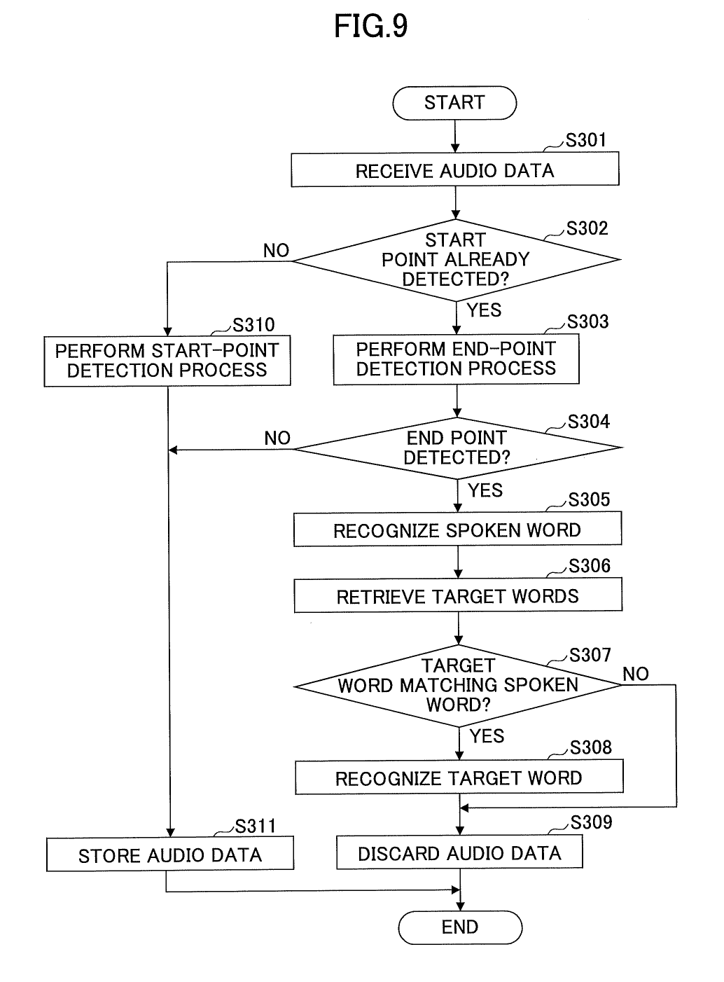

The speech recognition apparatus 1 of a second embodiment will be described by referring to FIG. 9. The present embodiment is directed to another example of a recognition process performed by the recognition unit 14. The hardware configuration and functional configuration of the speech recognition apparatus 1 of the present embodiment are the same as those of the first embodiment.

In the following, a description will be given of a recognition process performed by the recognition unit 14 according to the present embodiment. In the present embodiment, the recognition unit 14 recognizes a target word based on a segment (which will hereinafter be referred to as a “speech segment”) of audio data corresponding to speech which is included in the audio data produced by the sound collecting unit 11. To this end, the recognition unit 14 detects the start point and the end point of a speech segment. FIG. 9 is a flowchart illustrating an example of a recognition process according to the present embodiment.

The recognition unit 14 receives audio data from the acquisition unit 12 (step S301). In the case of not having already detected the start point of a speech segment (NO in step S302), the recognition unit 14 performs a process for detecting the start point of a speech segment based on the received audio data upon receiving the audio data from the acquisition unit 12 (step S310).

As the process for detecting the start point of a speech segment, the recognition unit 14 may use any proper detection process that utilizes the amplitude of audio data and mixture of Gaussian distribution.

Subsequently, the recognition unit 14 temporarily stores the audio data received from the acquisition unit 12 (step S311), followed by bringing the recognition process to an end.

In the case of having already detected the start point of a speech segment (YES in step S302), the recognition unit 14 performs a process for detecting the end point of a speech segment based on the received audio data upon receiving the audio data from the acquisition unit 12 (step S303). As the process for detecting the end point of a speech segment, the recognition unit 14 may use any proper detection process that utilizes the amplitude of audio data and mixture of Gaussian distribution.

In the case of not having detected the end point of a speech segment (NO in step S304), the recognition unit 14 temporarily stores the audio data received from the acquisition unit 12 (step S311), followed by bringing the recognition process to an end.

In the case of having detected the end point of a speech segment (YES in step S304), the recognition unit 14 recognizes a spoken word in response to the audio data obtained in step S301 and the temporarily stored audio data available from the start point of the speech segment. Namely, the recognition unit 14 recognizes a spoken word in response to the audio data from the start point to the end point of the speech segment. The spoken word, which refers to a word spoken by a user, corresponds to the audio data in the speech segment. The recognition unit 14 may recognize a spoken word by use of any proper method that utilizes acoustic information and linguistic information prepared in advance.

Upon recognizing the spoken word, the recognition unit 14 refers to the dictionaries stored in the dictionary memory 13 to retrieve the target words registered in the dictionaries (step S306).

In the case where the retrieved target words do not include a target word matching the spoken word (NO in step S307), the recognition unit 14 discards the temporarily stored audio data from the start point to the end point of the speech segment (step S309), followed by bringing the recognition process to an end.

In the case where the retrieved target words include a target word matching the spoken word (YES in step S307), the recognition unit 14 recognizes the target word matching the spoken word (step S308). The procedure thereafter proceeds to step S309.

The recognition process of the present embodiment is such that the detection of the end point of a speech segment triggers a speech recognition process. In this recognition process, only the process of detecting the start point and end point of a speech segment is performed until the end point of a speech segment is detected. With this arrangement, the load on the recognition unit 14 is reduced, compared with the recognition process of the first embodiment in which the score Sc of every target word is calculated every time a recognition process is performed.

The recognition unit 14 of the present embodiment may recognize a spoken word and retrieve the target words, followed by calculating similarity between the spoken word and the target words, and then recognizing a target word having the similarity exceeding a predetermined threshold. Minimum edit distance may be used as similarity. With minimum edit distance used as similarity, the recognition unit 14 may recognize a target word for which the minimum edit distance to the spoken word is smaller than the threshold.

Alternatively, the recognition unit 14 of the present embodiment may detect the end point of a speech segment, and may then calculate the score Sc of each target word in response to the audio data from the start point to the end point of the speech segment, followed by comparing the score Sc of each target word with the threshold Sth to recognize a target word. In this case, the recognition unit 14 may recognize, as in the first embodiment, the target word having the greatest difference between the score Sc and the threshold Sth among the one or more target words having the score Sc smaller than or equal to the threshold Sth.

### Third Embodiment

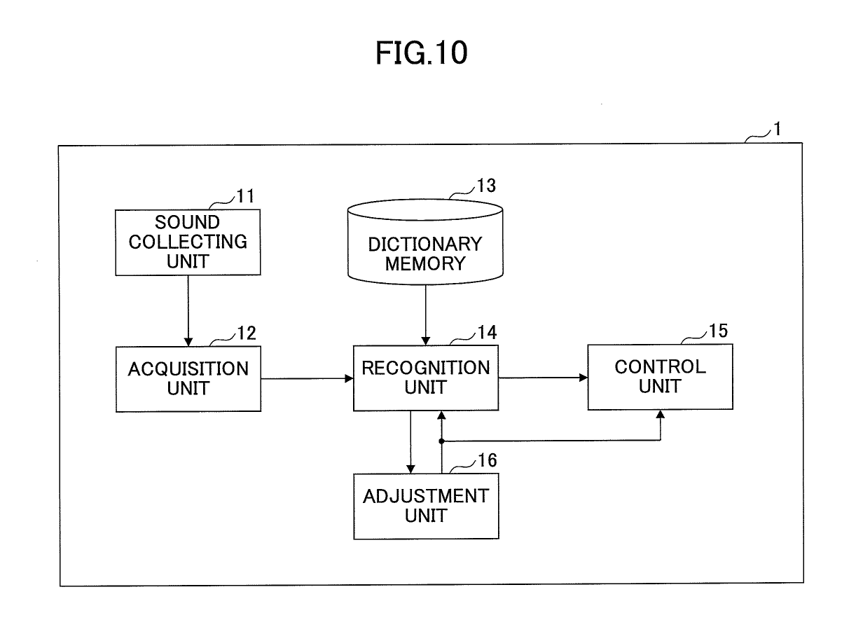

The speech recognition apparatus 1 of a third embodiment will be described by referring to FIG. 10 through FIG. 13. This embodiment is directed to adjustment of the cancellation period. The hardware configuration of the speech recognition apparatus 1 of the present embodiment is the same as those of the first embodiment.

In the following, a description will be given of the functional configuration of the speech recognition apparatus 1 according to the present embodiment. FIG. 10 is a drawing illustrating an example of the functional configuration of the speech recognition apparatus 1 according to the present embodiment. The speech recognition apparatus 1 of FIG. 10 further includes an adjustment unit 16. The adjustment unit 16 is implemented by the CPU 101 executing a program. The remaining functional configurations are the same as those of the first embodiment.

The adjustment unit 16 adjusts the cancellation period of a command word recognized by the recognition unit 14 in response to the reliability A of recognition of the command word. The reliability A of recognition is a value indicative of the reliability of a recognition result of a command word. The reliability A of recognition may be the difference (Sth−Sp) between the threshold Sth and a peak score Sp of a command word, for example. An increase in the difference between the threshold Sth and the peak score Sp means an increase in the reliability A of recognition. A decrease in the difference between the threshold Sth and the peak score Sp means a decrease in the reliability A of recognition.

The peak score Sp refers to a peak value of the score Sc of a command word. Specifically, the peak score Sp refers to the score Sc as observed at the point from which the score Sc starts to increase for the first time after the command word is recognized.

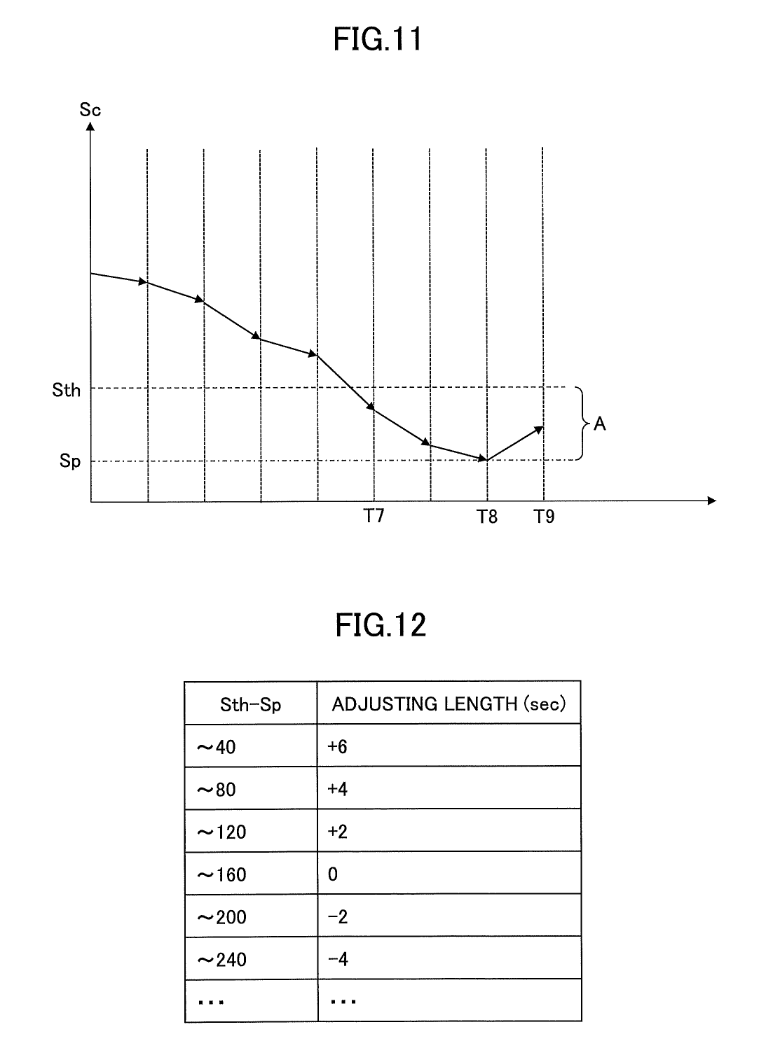

The reliability A of recognition will be described in detail by referring to FIG. 11. FIG. 11 is a graphic chart illustrating an example of transition of the score Sc with respect to a target word. In FIG. 11, the vertical axis represents the score Sc, and the horizontal axis represents time. The dashed line represents the threshold Sth, and the dot and dash line represents the peak score Sp. Further, the solid-line arrows in FIG. 11 represent the transitions of the score Sc with respect to a command word.

In the example illustrated in FIG. 11, the score Sc of the command word falls below the threshold Sth at time T7. The recognition unit 14 thus recognizes the command word at time T7. Subsequently, the score Sc of the command word monotonously decreases until time T8, followed by increasing at time T9. As illustrated in FIG. 11, the peak score Sp of the command word is the score Sc as observed at time T8 immediately preceding time T9 at which an increase in the score Sc occurs for the first time after time T7. The reliability A of recognition is the difference between the threshold Sth and the score Sc at time T8 (i.e., peak score Sp).

In the present embodiment, the recognition unit 14 continues calculating the score Sc of a command word for the duration of a predetermined detection period following the recognition of the command word for the purpose of calculating the reliability A of recognition (i.e., calculating the peak score Sp). The detection period may be 1 second, for example, but is not limited to this length. The detection period may be any length of time shorter than the cancellation period.

The adjustment unit 16 adjusts the cancellation period such that the greater the reliability A of recognition of a command word is, i.e., the lower the likelihood of false recognition of a command word is, the shorter the cancellation period is. This is because when the command word is correctly recognized, it is preferable to confirm the control operation associated with the command word early for the purpose of reducing the load on the control unit 15.

Further, the adjustment unit 16 adjusts the cancellation period such that the smaller the reliability A of recognition of a command word is, i.e., the higher the likelihood of false recognition of a command word is, the longer the cancellation period is. This is because when the command word is erroneously recognized, it is preferable to have a longer cancellation period.

The adjustment unit 16 may calculate an adjusting length for adjusting the cancellation period in response to the reliability A of recognition. Alternatively, the adjustment unit 16 may have an adjusting length table in which adjusting lengths are registered in one-to-one correspondence with different reliabilities A of recognition. In this case, the adjustment unit 16 may refer to the adjusting length table to retrieve an adjusting length corresponding to the reliability A of recognition.

FIG. 12 is a drawing illustrating an example of an adjusting length table. In the example illustrated in FIG. 12, the reliability A of recognition is the difference (Sth−Sp) between the threshold Sth and the peak score Sp. In the case of the difference (Sth−Sp) being smaller than 40, the adjusting time is +6 seconds. In the case of the reliability A of recognition being greater than or equal to 200 and smaller than 240, the adjusting time is −4 seconds. In this manner, adjusting lengths are registered such that the smaller the difference between the threshold Sth and the peak score Sp (i.e., the reliability A) is, the longer the cancellation period is. Further, adjusting lengths are registered such that the greater the difference between the threshold Sth and the peak score Sp (i.e., the reliability A) is, the shorter the cancellation period is.

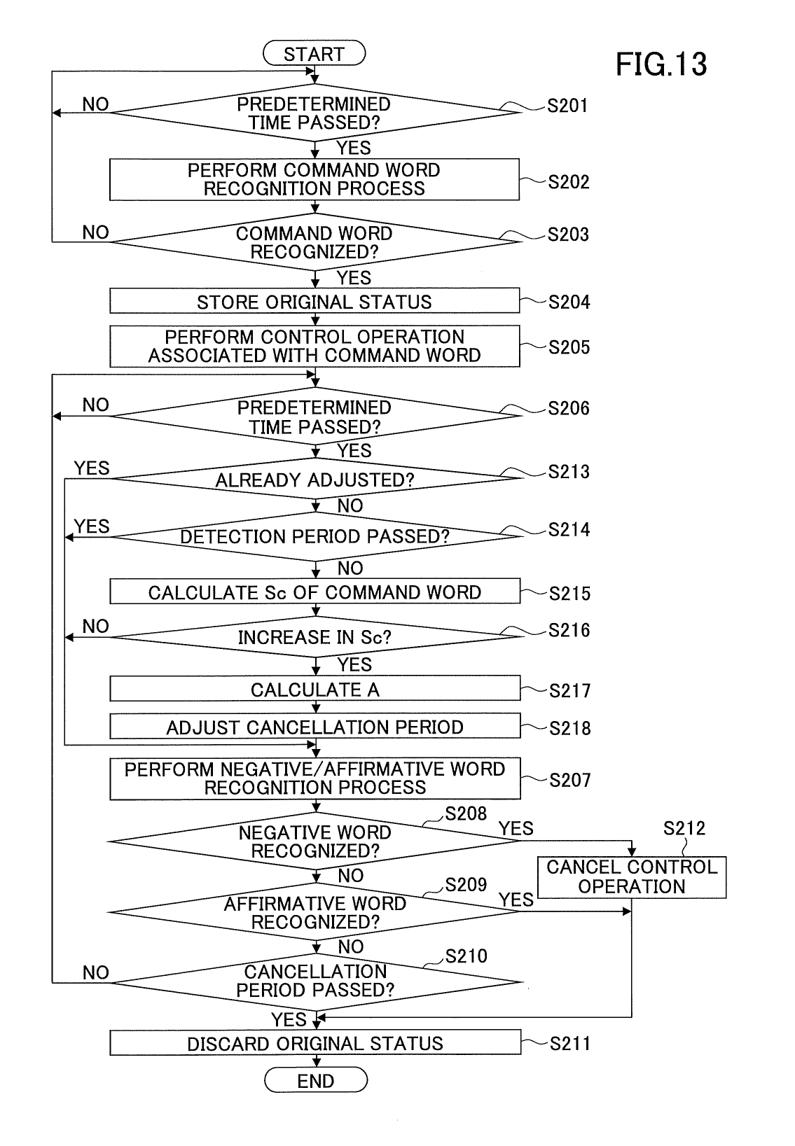

In the following, a description will be given of a process performed by the speech recognition apparatus 1 of the present embodiment. FIG. 13 is a flowchart illustrating an example of the process performed by the speech recognition apparatus 1 of the present embodiment. The flowchart of FIG. 13 is what is obtained by inserting steps S213 through S218 between step S206 and step S207 of the flowchart illustrated in FIG. 7. In the following, steps 5213 through S218 will be described.

Upon the passage of a predetermined time period following the recognition of a command word (YES in step S206), the recognition unit 14 checks whether the cancellation period has already been adjusted by the adjustment unit 16 (step S213). In the case in which the cancellation period has already been adjusted (YES in step S213), the procedure proceeds to step S207.

In the case in which the cancellation period has not been adjusted by the adjustment unit 16 (NO in step S213), the recognition unit 14 checks whether the detection period has passed since the recognition of a command word (step S214). In the case in which the detection period has passed (YES in step S214), the procedure proceeds to step S207.

In the case in which the detection period has not passed (NO in step S214), the recognition unit 14 calculates the score Sc of the command word (step S215).

Having calculated the score Sc of the command word, the recognition unit 14 checks whether the calculated score Sc exhibits an increase from the previously calculated score Sc (step S216). In the case in which the score Sc of the command word does not show an increase (NO in step S216), the procedure proceeds to step S207.

In the case in which the score Sc of the command word shows an increase (YES in step S216), the recognition unit 14 calculates the reliability A of recognition (step S217). Specifically, the recognition unit 14 calculates the difference between the threshold Sth of the command word and the score Sc of the command word of the immediately preceding calculation period. This is because, as was described in connection with FIG. 11, the score Sc of the command word of the immediately preceding calculation period is the peak score Sp of the command word in the case in which the most recently calculated score Sc of the command word exhibits an increase. Upon calculating the reliability A of recognition, the recognition unit 14 sends the calculated reliability A of recognition and the cancellation period of the command word to the adjustment unit 16.

Upon receiving the reliability A of recognition and the cancellation period from the recognition unit 14, the adjustment unit 16 adjusts the cancellation period based on the reliability A of recognition (step S218). Specifically, the adjustment unit 16 refers to the adjusting length table to retrieve an adjusting length corresponding to the reliability A of recognition, followed by adding the retrieved adjusting length to the cancellation period. Alternatively, the adjustment unit 16 may calculate an adjusting length in response to the reliability A of recognition. Upon adjusting the cancellation period, the adjustment unit 16 sends the adjusted cancellation period to the recognition unit 14 and the control unit 15. The procedure thereafter proceeds to step S207. In the subsequent part of the procedure, the recognition unit 14 and the control unit 15 perform processes by use of the adjusted cancellation period.

According to the present embodiment described above, the cancellation period is adjusted based on the reliability A of recognition of a command word. This arrangement allows the cancellation period to be adjusted to a proper length in response to the likelihood of occurrence of false recognition.

In the present embodiment, the reliability A of recognition is not limited to the difference between the threshold Sth and the peak score Sp. The reliability A of recognition may be any value that indicates the reliability or accuracy of a recognized command word in response to a recognition process. For example, the reliability A of recognition may be a value obtained by dividing the difference between the threshold Sth and the peak score Sp by a reference value such as the threshold Sth. In the case in which the recognition unit 14 performs a recognition process of the second embodiment, the reliability A of recognition may be the difference between similarity (e.g., the minimum edit distance) and a threshold, or may be a value obtained by dividing such a difference by a reference value such as the threshold.

### Fourth Embodiment

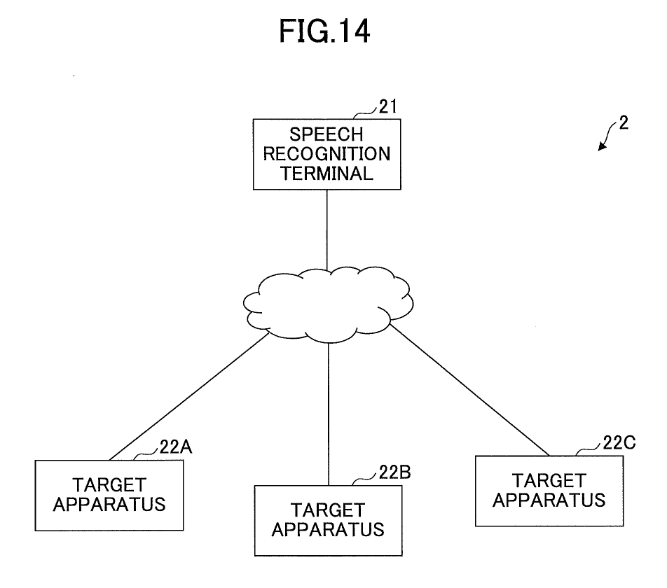

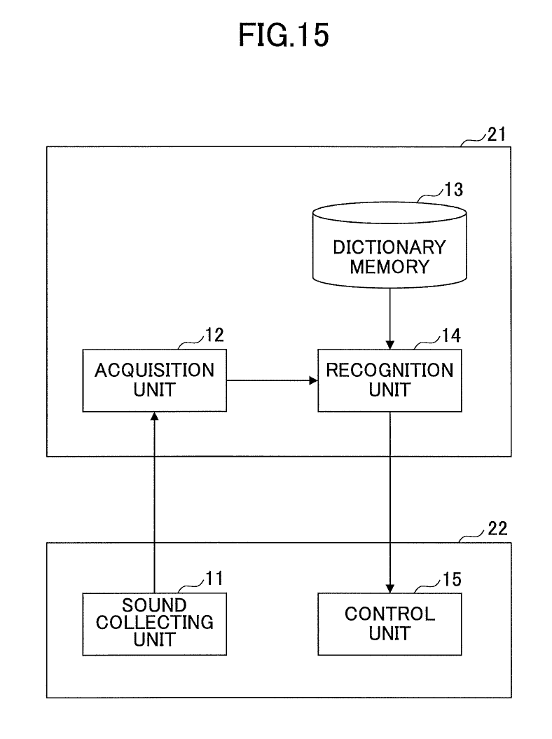

A speech recognition system 2 of a fourth embodiment will be described by referring to FIG. 14 through FIG. 15. The speech recognition system 2 of the present embodiment implements similar functions to those of the speech recognition apparatus 1 of the first embodiment.

FIG. 14 is a drawing illustrating an example of the speech recognition system 2 according to the present embodiment. The speech recognition system 2 illustrated in FIG. 14 includes a speech recognition terminal 21 and a plurality of target apparatuses 22A through 22C, which are connected to each other through a network such as the Internet or a LAN.

The speech recognition terminal 21 receives audio data from the target apparatuses 22A through 22C, and recognizes target words in response to the received audio data, followed by transmitting the results of recognition to the target apparatuses 22A through 22C. The speech recognition terminal 21 may be any apparatus communicable through a network. In the present embodiment, a description will be given with respect to an example in which the speech recognition terminal 21 is a server.

The hardware configuration of the speech recognition terminal 21 is the same as that shown in FIG. 1. It may be noted, however, that the speech recognition terminal 21 may not have a microphone because the speech recognition terminal 21 receives audio data from the target apparatuses 22A through 22C.

Each of the target apparatuses 22A through 22C transmits audio data received from the microphone to the speech recognition terminal 21, and receives the results of recognition of a target word from the speech recognition terminal 21. The target apparatuses 22A through 22C operate in accordance with the results of recognition received from the speech recognition terminal 21. The target apparatuses 22A through 22C may be any apparatus capable of communicating through the network and acquiring audio data through a microphone. Such apparatuses include an on-vehicle apparatus, an audio apparatus, a television set, a smartphone, a portable phone, a tablet terminal, a PC, and the like, for example. The present embodiment will be described by referring to an example in which the target apparatuses 22A through 22C are on-vehicle apparatuses. In the following, the target apparatuses 22A through 22C will be referred to as target apparatuses 22 when the distinction does not matter.

The hardware configuration of the target apparatuses 22 is the same as that shown in FIG. 1. Although the speech recognition system 2 includes three target apparatuses 22 in the example illustrated in FIG. 14, the number of target apparatuses 22 may be one, two, or three or more. Further, the speech recognition system 2 may include different types of target apparatuses 22.

In the following, a description will be given of the functional configuration of the speech recognition system 2 according to the present embodiment. FIG. 15 is a drawing illustrating an example of the functional configuration of the speech recognition system 2 according to the present embodiment. The speech recognition terminal 21 illustrated in FIG. 15 includes the acquisition unit 12, the dictionary memory 13, and the recognition unit 14. The target apparatus 22 illustrated in FIG. 15 includes the sound collecting unit 11 and the control unit 15. These functional units are the same as those of the first embodiment. It may be noted, however, that the control unit 15 controls the target apparatus 22 rather than the speech recognition terminal 21.

According to the configuration as described above, the speech recognition system 2 of the present embodiment performs the same or similar processes as those of the first embodiment to produce the same or similar results as those of the first embodiment. Unlike in the first embodiment, however, the results of recognizing audio data and target words are transmitted and received through a network.

According to the present embodiment, a single speech recognition terminal 21 is configured to perform recognition processes for a plurality of target apparatuses 22. This arrangement serves to reduce the load on each of the target apparatuses 22.

The dictionary memory 13 of the speech recognition terminal 21 may store dictionaries which have target words registered therein that are different for each target apparatus 22. Further, the recognition unit 14 of the speech recognition terminal 21 may perform a recognition process of the second embodiment. Moreover, the speech recognition terminal 21 may be provided with the adjustment unit 16.

The present invention is not limited to the configurations described in connection with the embodiments that have been described heretofore, or to the combinations of these configurations with other elements. Various variations and modifications may be made without departing from the scope of the present invention, and may be adopted according to applications.

The present application is based on Japanese priority application No. 2017-008105 filed on Jan. 20, 2017, with the Japanese Patent Office, the entire contents of which are hereby incorporated by reference.

What is claimed is

1. A speech recognition apparatus, comprising:
a recognition unit configured to perform, in response to audio data, a recognition process with respect to a first word registered in advance and a recognition process with respect to a second word registered in advance, the recognition process with respect to the second word being performed during a cancellation period associated with the first word upon the first word being recognized; and
a control unit configured to perform a control operation associated with the recognized first word upon the first word being recognized by the recognition unit, and to cancel the control operation upon the second word being recognized by the recognition unit.

2. The speech recognition apparatus as claimed in claim 1, wherein the recognition unit is configured to perform a recognition process with respect to a third word registered in advance during the cancellation period associated with the recognized first word upon recognizing the first word.

3. The speech recognition apparatus as claimed in claim 2, wherein the recognition unit is configured to terminate the recognition process with respect to the second word upon recognizing the third word.

4. The speech recognition apparatus as claimed in claim 1, further comprising an adjustment unit configured adjust a length of the cancellation period in response to a reliability of recognition of the recognized first word.

5. The speech recognition apparatus as claimed in claim 4, wherein the adjustment unit is configured to adjust the length of the cancellation period such that the greater the reliability of recognition of the recognized first word is, the shorter the length of the cancellation period is.

6. The speech recognition apparatus as claimed in claim 1, wherein the first word and the second word are registered in respective, different dictionaries.

7. The speech recognition apparatus as claimed in claim 1, wherein the first word and the second word are registered in a same dictionary.

8. The speech recognition apparatus as claimed in claim 1, wherein the recognition unit is configured to calculate similarity between the audio data and the first word at constant intervals, and to recognize the first word in response to the calculated similarity.

9. A method of speech recognition, comprising:
performing, in response to audio data, a first recognition process with respect to a first word registered in advance and a second recognition process with respect to a second word registered in advance, the second recognition process being performed during a cancellation period associated with the first word upon the first word being recognized by the first recognition process; and
performing a control operation associated with the recognized first word upon the first word being recognized by the first recognition process, and cancelling the control operation upon the second word being recognized by the second recognition process.

10. A speech recognition system, comprising:
a speech recognition terminal; and
one or more target apparatuses connected to the speech recognition terminal through a network,
wherein the speech recognition terminal includes a recognition unit configured to perform, in response to audio data, a recognition process with respect to a first word registered in advance and a recognition process with respect to a second word registered in advance, the recognition process with respect to the second word being performed during a cancellation period associated with the first word upon the first word being recognized, and
wherein at least one of the target apparatuses includes a control unit configured to perform a control operation associated with the recognized first word upon the first word being recognized by the recognition unit, and to cancel the control operation upon the second word being recognized by the recognition unit.
